(19) United States
(12) Patent Application Publication
(10) Pub. No.: US 2014/0232368 A1
(43) Pub. Date: Aug. 21, 2014

(54) ELECTRIC POWER CONVERSION WITH ASSYMETRIC PHASE RESPONSE

(71) Applicant: NVIDIA CORPORATION, Santa Clara, CA (US)

(72) Inventor: William James Dally, Los Altos Hills, CA (US)

(73) Assignee: NVIDIA CORPORATION, Santa Clara, CA (US)

(21) Appl. No.: 13/770,656

(22) Filed: Feb. 19, 2013

(51) Int. Cl. H02M 3/155

(52) U.S. Cl. CPC H02M 3/155
USPC 323/311

(57) ABSTRACT

The disclosure is directed to a multi-phase electric power conversion device coupled between a power source and a load. The device includes a first regulator phase and a second regulator phase arranged in parallel, so that a first phase current and a second phase current are controllably provided in parallel to satisfy the current demand requirements of the load. Each phase current is based on current generated in an energy storage device within the respective phase. The regulator phases are asymmetric in that the energy storage device of the second regulator phase is configured so that its current can be varied more rapidly than the current in the energy storage device of the first regulator phase.

### BACKGROUND

Power supplies play an important role in the performance of microprocessors and other electronic devices. Power supplies must provide an appropriate amount of current and voltage over a range of operating conditions. Current and voltage must be supplied in an efficient and stable manner at steady state, and as conditions change the power supply must respond quickly to transient demands, such as an increase or decrease in the amount of current drawn by a load. As components come “online,” for example, current demands may increase dramatically, and demand in turn will decrease significantly as components go “offline.” As such, typical electric power conversion devices (e.g., voltage regulators) may utilize one or more energy storage devices, such as capacitors and inductors, in order to ensure that enough energy is available to provide the desired current. However, as the storage devices increase in size, the ability to respond quickly is proportionally diminished.

### BRIEF DESCRIPTION OF THE DRAWINGS

FIG. 1 schematically depicts a single phase electric power conversion device.

FIGS. 2-4 schematically depict example embodiments of multi-phase electric power conversion devices according to the present disclosure.

FIG. 5 depicts an exemplary method of controlling electric current delivery so as to satisfy current requirements of a load.

### DETAILED DESCRIPTION

Electronic devices typically employ various power conversion mechanisms—e.g., voltage regulators, stepping down of voltages—in order to obtain voltage and current having characteristics that can be used by the device. Conversion devices are configured to operate over a range of operating conditions. For example, current requirements of CPUs and other devices fluctuate over time. Current requirements can vary rapidly, for example increased demands when a block of logic is restarted after a stall, or when a new request starts a large computation. When components go offline or processes come to an end, current requirements may rapidly decrease. Electric power conversion devices need to handle these changing demands/requirements and provide voltage and current within a desired range.

The examples herein contemplate using multiple voltage regulator phases arranged to deliver currents in parallel to a load. Each phase can provide a portion of the current required by the load, such that the phases cooperate to satisfy the load's current requirements. The phases are asymmetrical, in the sense that they are able to respond in different ways to the changing current demands of the load, such as in the case of non-trivial positive or negative transients. Some examples make use of additional or auxiliary phases capable of operating at higher frequencies, and/or in a manner that allows them to vary the current that they supply more rapidly than other phases. For example a main phase can operate to supply all or the majority of the current needed by the load, and a faster auxiliary phase can supply current at levels that are smaller but more quickly adjusted, for example to rapidly handle an increase in current demanded by the load. These and other examples will be described in detail after describing an example of single-phase current delivery.

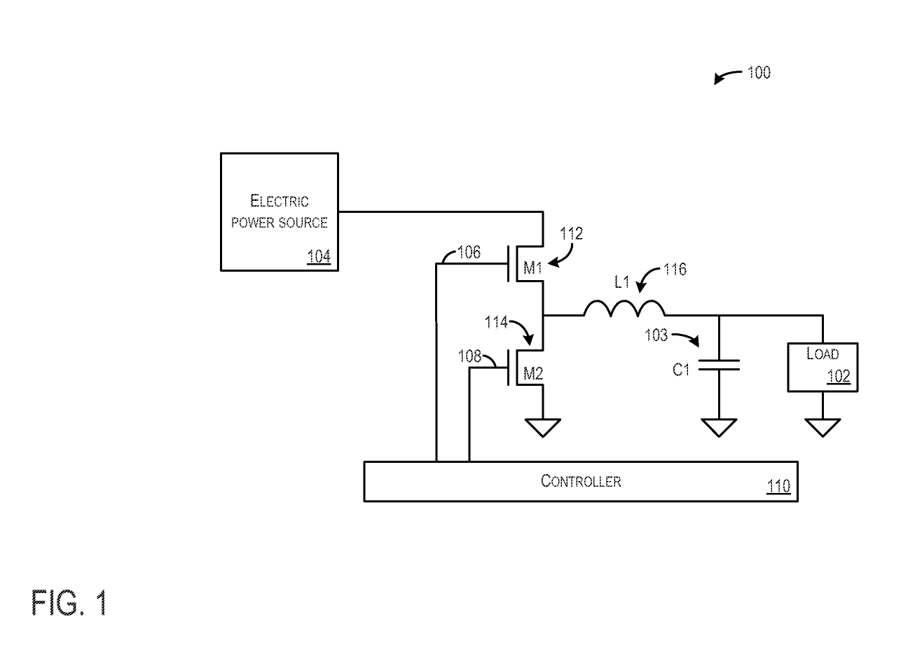

Turning now to FIG. 1, a typical power conversion device 100 is shown. Device 100 is configured to provide a desired output (e.g., 1V DC) to load 102 (e.g., logic “blocks,” etc.) and capacitor 103 by converting power received from electric power source 104 (e.g., battery, mains power, etc.). Specifically, the configuration shown in FIG. 1 is typically referred to as a “buck” converter. While the present invention is described in the context of this buck converter, one of ordinary skill in the art will understand that this invention can be applied to other “switch-mode” power conversion circuits including, but not limited to, a forward converter, a half-bridge converter, a full-bridge converter, a flyback converter, and/or variants thereof.

By modulating the duty factor of control signals 106 and 108 (e.g., PWM signals, PFM signals, etc.), controller 110 is configured to selectively enable transistors 112 and 114, respectively. In doing so, controller 110 is able to modulate the average current flowing through inductor 116. Specifically, by enabling transistor 112, the instantaneous current flowing through inductor 116 is increased, whereas the instantaneous current is decreased by enabling transistor 114. The difference between the current flowing through the inductor and the load current is accumulated on capacitor 103. Thus, the output voltage provided to load 102 can be controlled by controlling the current through inductor 116.

However, the inductor also resists changes in current, thereby preventing the stored energy in inductor 116 from being released all at once (e.g., to load 102) when load current changes. This property of inductors, along with the storage capacity of capacitor 103, enables an output voltage at load 102 that is sufficiently stable during steady-state operation. Nonetheless, there is some “ripple” in the voltage at load 102 that depends on the size of inductor 116, the size of capacitor 103, and/or the switching frequency of the controller 110, among other factors. Generally speaking, as the size of inductor 116 increases, the output ripple at steady state proportionally decreases. Accordingly, inductor 116 may be sized large enough in order to provide an output voltage that does not fluctuate outside a desired voltage range. However, it will be appreciated that the tendency of inductor 116 to resist a change in current may be undesirable during a rapid increase or decrease in current (referred to as “transients”) demanded by load 102.

An example configuration of device 100 (e.g., typical 30 A regulator phase), is as follows. Inductor 116 is 0.5 μH, electric power source 104 provides 12V DC, and the desired output to load 102 is 1V DC. Ignoring the voltage drop across transistor 112 (e.g., due to a small channel resistance) and other non-idealities, the voltage drop across inductor 116 is 11V. As such, the maximum (ideal) current response from inductor 116, defined as the voltage divided by the inductance, is 22 A/μs. Accordingly, providing an extra 10 A of current to load 102 will take at least 500 ns, even ignoring other non-idealities (e.g., time to synchronize control signals 106 and 108 to new demands). While the current being provided is less than the current demanded by load 102, the voltage seen at load 102 will begin to drop as capacitor 103 is discharged by the current difference. If the voltage drops too far, load 102 may operate incorrectly. It will be thus appreciated that such performance may be unsatisfactory in some high-performance electronic devices.

If desired voltage characteristics cannot be satisfied, load 102 may be configured to employ various techniques to deal with the provided voltage. For example, load 102 (e.g., computing device), may be configured to “throttle” performance upon detecting a voltage that is outside, or near an extreme of, the desired voltage range. Throttling may include, for example, halting pending operations, decreasing clock frequency to allow greater time for edge transitions, and/or otherwise decreasing throughput. However, it will be appreciated that such performance modifications may be undesirable in some use scenarios.

Accordingly, in order to provide faster transient response, other typical electric power conversion devices may utilize a plurality of “phases” operating in parallel in order to provide the desired load current. Such a configuration may be desirable, for example, as each phase may be able to utilize relatively smaller energy storage devices compared to single-phase electric power conversion devices, thereby potentially decreasing amount of space used.

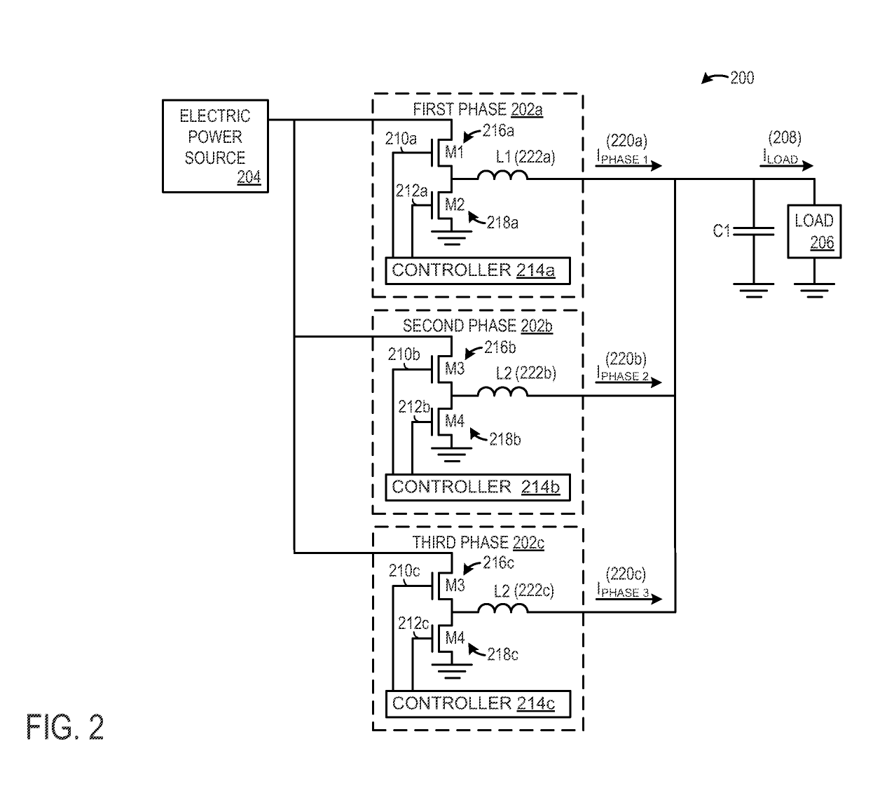

Turning now to FIG. 2, a multi-phase power conversion device 200 according to an embodiment of the present disclosure is schematically shown. Device 200 includes multiple asymmetric phases 202 each coupled between electric power source 204 and load 206 and configured to deliver a portion of load current 208 to the load. Specifically, each phase 202 may be configured to operate at a different frequency. As used herein, the term “high-frequency phase” will be used to refer to any phase of a multi-phase electric power conversion device that is configured to operate at a higher frequency than a “main phase” of the conversion device. In the present example, phase 202a may be considered the main phase, with phases 202b and 202c being high frequency phases. In some cases, it will also be appropriate to refer to phases 202b and 202c as “auxiliary phases.”

Each phase 202 of device 200 modulates signals 210 and 212 (e.g., via control mechanism 214) provided to transistors 216 and 218, respectively, in order to control a portion of load current 208 (i.e., phase current 220) supplied to the load. In other words, each phase 202 provides an individual phase current 220, and the plurality of phase current(s) are delivered in parallel in order to satisfy load current 208 demands.

Phases 202 may be variously configured in order to satisfy changing current demands of the load. In one example, main phase 202a may be configured to provide substantially all of load current 208 during normal device operation when current requirements are substantially constant. In other words, energy storage device 222a (e.g., inductor) of main phase 202a may be sized, or otherwise configured, to provide load current 208 to load 206 during normal operation with an amount of “ripple” below a desired threshold. As the size of an inductor increases, so too does the resistance in changes to current flowing through the inductor; the inductor therefore operates to temper fluctuations (e.g., “ripple”) in the current. While energy storage device 222a may therefore provide suitable performance over the range of normal operating conditions, such an energy storage device may be unsuitable to provide desired transient response characteristics—i.e., too slow of response.

Second phase 202b and third phase 202c may therefore be configured as auxiliary phases to provide improved current transient response. Specifically, energy storage device 222b of second phase 202b may be smaller than (e.g., store less energy than) energy storage device 222a of first/main phase 202a, thereby enabling second phase current 220b to vary faster than first phase current 220a. Similarly, energy storage device 222c of third phase 202c may be smaller than both energy storage devices 222a and 222b, thereby enabling third phase current 220c to be varied faster than both first phase current 220a and second phase current 220b.

As one non-limiting example, main phase 202a may include energy storage device 222a having an inductance of 0.5 uH, and may be configured to switch transistors 216a and 218a at 330 KHz via control signals 210a and 212a, respectively. Second phase 202b may include energy storage device 222b having an inductance of 50 nH (i.e., 10× smaller than device 222a) and may be configured to switch transistors 216b and 218b at 3.3 MHz (i.e., 10× faster than main phase 202a). Furthermore, inductor 222c may be sized 10X smaller than inductor 222b, while transistors 216c and 218c are switched 10X faster than transistors 216b and 218b.

Since inductor 222b is 10× smaller than inductor 222a, second phase 202b may be able to respond to current transients 10× faster than main phase 202a. However, it will be appreciated that such faster switching comes at the expense of increased (e.g., 10× increased) switching losses via second phase 220b. It will therefore be further appreciated that it may be desirable to selectively utilize the auxiliary phase(s) on an as-needed basis. When third phase 202c is employed, switching losses may be even higher.

Accordingly, it may be desirable during normal operating conditions to disable auxiliary phases 202b and 202c (e.g., no switching of transistors 216b, 218b, 216c, 218c) such that phase currents 220b and 220c are substantially zero; first phase 202a therefore provides substantially all of load current 208 demanded by load 206 via phase current 220a during normal operation.

Upon occurrence of a positive current transient (i.e., increase demand for load current 208), first phase 202a may be unable to respond to such current demand changes in a suitable amount of time. Thus, upon recognizing a positive current transient, control mechanism 214b may modulate control signals 210b and/or 212b of second phase 202b in order to increase second phase current 220b until such increase is no longer needed to satisfy the current requirements of the load. In other words, second phase 202b is quickly activated to generate second phase current 220b to supplement first phase current 220a. As the first phase “catches up” (e.g., current is increased through energy storage device 222a) and is eventually able to satisfy substantially all of the load current demands, operation of second phase 302b can be “tapered-off” (e.g., duty factor of signals 210b and 212b gradually reduced). In some cases, the transient may be short lived, such that second phase 202b is turned off without needing an increase from the main phase.

Similar to the described operation of second phase 202b, third phase 202c and, if applicable, additional phases may be activated in response to a positive current transient. As third phase 202c can respond even faster than second phase 202b (e.g., 10X faster), it may also be activated in response to a recognized positive current transient to provide an even faster response. As the prior phases ramp up to satisfy the increase, the third phase and then the second phase may be turned off successively until the main phase is again able to handle all of the load requirements. On the other hand, as in the above example, the transient may be short lived such that the additional phases can be turned off without the main phase needing to catch up.

Auxiliary phases 202b and 202c may also be configured to respond quickly to negative transients. In this example, the auxiliary phases may be warmed up so that they handle some portion of the current needed during normal operation, in contrast to the above example. Then, in the event of a negative transient, the excess current (i.e., phase currents 220b and/or 220c) is discharged through energy storage devices 222b and/or 222c and, eventually, to ground by appropriately switching the transistors of the auxiliary phases. Again, the relatively smaller sizing of the components and the higher operating frequencies allow the auxiliary phases to handle this more quickly than is possible via the main phase. As with positive transients, the main phase may eventually catch up if the change in demand persists, such that the phase currents 220b and 220c may return to their prior levels.

It will be appreciated that the depicted three-phase configuration is presented as one non-limiting example. Generally speaking, a multi-phase electric power conversion device may include any suitable number and configuration of phases (e.g., switching frequency, regulator topology, etc.).

Although multi-phase electric power conversion device 200 may be able to provide suitable performance in some scenarios, it will be appreciated that the frequency response may be limited by the switching times and the types of the transistors in each phase. For example, the voltage of electric power source 204 may require use of power MOSFETs, which provide less desirable performance than transistors that can switch at lower voltages (e.g., “planar” transistors). As such, it will be appreciated that it may be desirable to operate at least some of the phases of an electric power conversion device via a decreased input voltage.

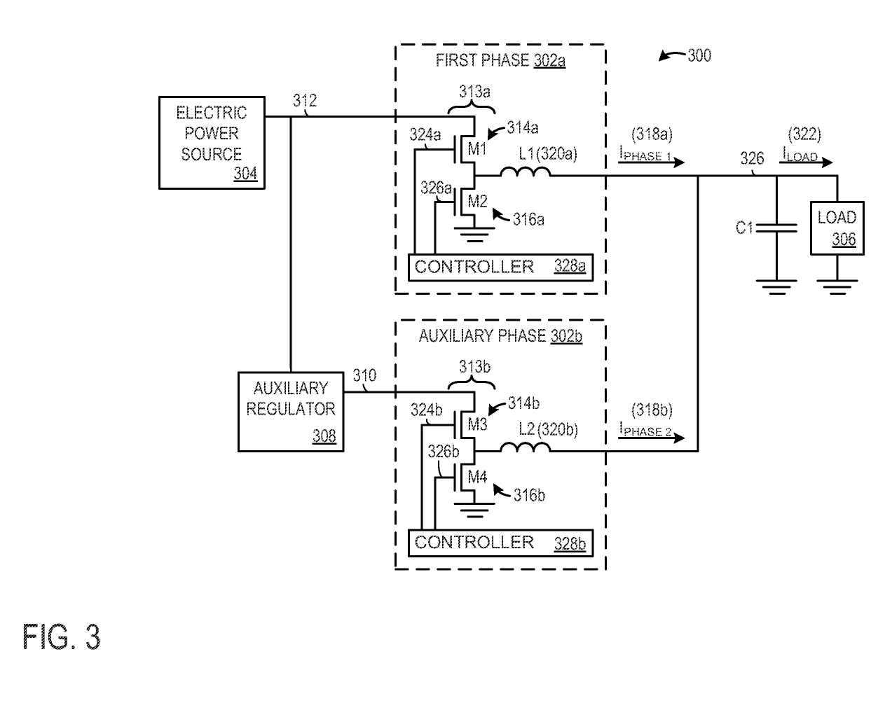

FIG. 3 schematically illustrates a multi-phase electric power conversion device 300 according to another embodiment of the present disclosure that can be implemented in part with a lower voltage to one or more phases. Similar to the above example, device 300 includes a main phase 302a and an auxiliary phase 302b coupled between electric power source 304 and load 306. However, whereas each phase 202 of device 200 was coupled directly to electric power source 204, device 300 further includes an auxiliary power supply/source in the form of auxiliary regulator 308, which is coupled between electric power source 304 and auxiliary phase 302b. As mentioned above, switching the input voltage of source 304 may be slow and require relatively more space (e.g., using power MOSFETs), and/or may otherwise be undesirable; the operation of auxiliary regulator 308 to provide a reduced voltage to auxiliary phase 302b may enable use of more suitable/desirable switching mechanisms and related components (e.g., switching with planar MOSFETs).

Although described as a “regulator,” auxiliary regulator 308 may utilize any combination of mechanisms, topologies, etc. (e.g., buck converter 100 of FIG. 1) to provide a voltage to auxiliary phase 302b at node 310 that is less than a voltage provided by electric power source 304 at node 312. Furthermore, although illustrated as providing an output at node 310 based on an input from node 312, it will be appreciated the auxiliary supply may be configured to receive electrical power from a power source that is substantially isolated from electric power source 304 in some embodiments.

As one non-limiting example, some integrated circuits may include a 2.5V or 1.8V supply provided to various integrated circuit devices (e.g., I/O circuits), while electric power source 304 may provide 12V; the lower-voltage supply may be coupled to auxiliary phase 302b, thereby enabling phase 302b to provide improved transient response as compared to main phase 302a.

As mentioned above, a lower voltage provided to auxiliary phase 302b may enable utilization of switching mechanism 313b that is relatively faster than switching mechanism 313a of first phase 302a. As one non-limiting example, first phase switching mechanism 313a may include transistors 314a and 316a realized via power MOSFETs, whereas second phase switching mechanism 313b may include transistors 314b and 316b realized via faster switching planar devices. Generally speaking, first phase 302a is configured to selectively provide first phase current 318a to the load which is based on current generated in the first phase energy storage device 320a, and second phase is configured to selectively provide second phase current 318b in parallel with first phase current 318a and based on current generated in second phase energy storage device 320b.

As transistors 314b and 316b of second phase 302b may be able to provide relatively faster switching, second phase energy storage device 320b may be substantially smaller than first phase energy storage device 320a, and second phase 302b may therefore be able to potentially provide current more rapidly in response to a transient. In some embodiments, the relatively smaller size of energy storage device 320b may be realized via a spiral inductor. Although illustrated as single inductors, it will be appreciated that energy storage devices 320 may include any suitable alternate configuration.

Similar to device 200 of FIG. 2, device 300 may be configured such that, during normal operation, substantially all of load current 322 provided to load 306 is realized via switching of transistors 314a and 316a of first phase 302a. In other words, during normal operating conditions in which the current requirements are substantially constant, control mechanism 328a controls the first regulator phase so that the first phase current satisfies substantially all of the current requirements of the load, and where the second phase current is provided only in response to a current transient. Such switching may be provided, for example, via modulation of control signals(s) (e.g., control signals 324a and 326a) provided via control mechanism 328a. First phase 302a may be able to provide such load current during normal operation at a relatively higher efficiency compared to second phase 302b, and therefore operation of first phase 302a without assistance from phase 302b may be desirable during normal, non-transient operation when current requirements are substantially constant. Accordingly, transistors 314b and 316b would not be switched during normal operation.

In the event of a positive current transient (i.e., increased load current 322 demand), the control mechanism (i.e., controller 328a and/or 328b) may be further configured to respond to the transient by dynamically varying control signals provided to one or both of the first phase switching mechanism (e.g., control signals 324a and 326a) and the second phase switching mechanism (e.g., control signals 324b and 326b).

For example, in some embodiments, controller 328b may be configured to fully enable transistors 314b (e.g., provide control signal 324b with a duty factor substantially near 1). In other embodiments, control signals 324b and/or 326b may be switched according to any other duty factor, schema, etc. in order to provide increased second phase current 318b. Once current generated in energy storage device 320b reaches a suitable level, operation of second phase switching mechanism 313b may continue to provide increased second phase current 318b until such increase is no longer needed to satisfy the current requirements of the load (e.g., until the first/main phase catches up). Once second phase current 318b is no longer needed, second phase switching mechanism 313b may be disabled until future transient(s) are recognized.

Similar to the above example, auxiliary phase 302b may be configured to provide some of the load current during normal operation, as opposed to being turned off during such times, so that it can be quickly turned off or ramped down in the event of a negative transient. Also, as with the three phases of device 200, it will be appreciated that the two-phase configuration of device 300 is presented for the purpose of example, and is not intended to be limiting in any manner. For example, in other embodiments, the system may be implemented with more than one additional/auxiliary phases.

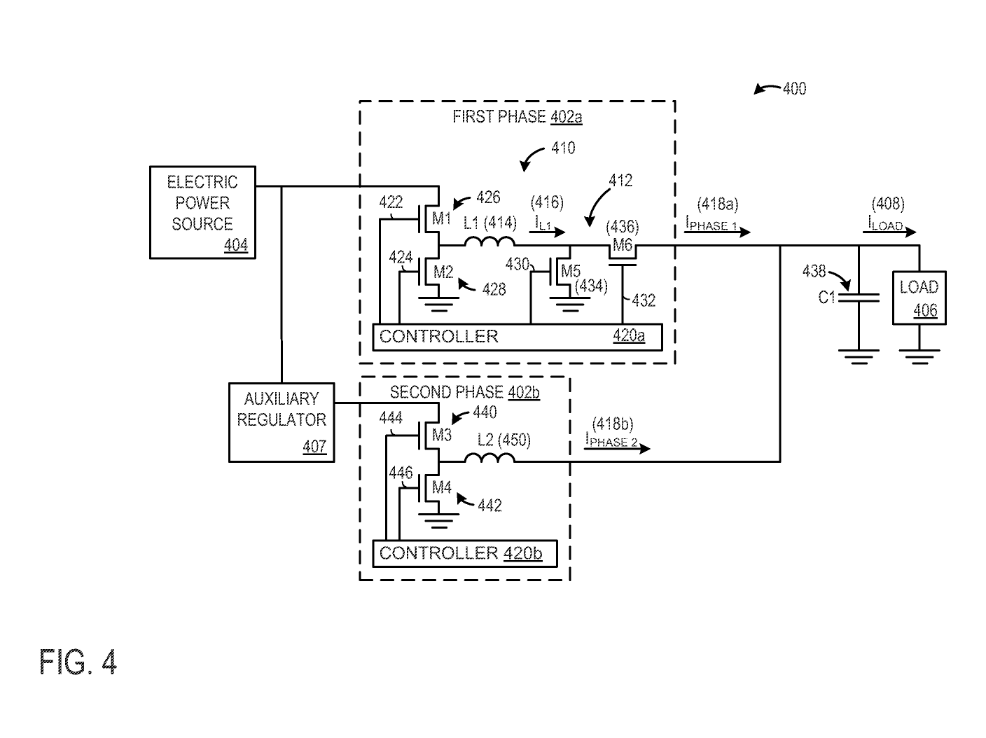

Turning now to FIG. 4, the figure shows another example embodiment of a multi-phase electric power conversion device 400. As will be described in detail below, device 400 includes components that implement a technique that will be referred to as “current parking.” Current parking provides a further mechanism for responding to changes in load current demands. One particular advantage of the current parking feature is that it can allow for a rapid and efficient response to a negative current transient.

Continuing with the figure, device 400 includes a first/main phase 402a and a second/auxiliary phase 402b coupled between electric power source 404 and load 406. An auxiliary regulator 407 is coupled between the power source and the auxiliary phase. As in other examples, main phase 402a may be implemented to provide substantially all of load current 408 to load 406 during normal operation. However, in contrast to previous embodiments, first phase switching mechanism 410 further includes current parking switching mechanism 412 coupled between first phase energy storage device 414 and the load. The current parking switching mechanism is configured to control how much of current 416 generated in the first phase energy storage device is provided as first phase current 418a to the load.

Current 416 in the first phase energy storage device (inductor 414a) is generated as in the previous examples. Specifically, controller 420a provides control signals 422 and 424 to respectively control the switching of transistors 426 and 428. The transistors typically will be controlled with selected duty cycles and so as to be in complementary states (unless both are turned off).

All, some, or none of current 416 may be provided as the first phase current 418a, depending on operation of current parking switching mechanism 412. Controller 420a provides control signals 430 and 432 to respectively control the switching of transistors 434 and 436. The transistors typically will be controlled with selected duty cycles and so as to be in complementary states.

When transistor 434 is enabled and transistor 436 is disabled, all of the instantaneous current 416 is diverted through the transistor to ground, such that none of current 416 is provided to the load as the first phase current 418a. Conversely, when transistor 434 is disabled and transistor 436 is enabled, substantially all of current 416 is provided to the load as first phase current 418a. Duty-cycle toggling of the transistor states results in a controllable intermediate amount of current 416 to be provided to the load as first phase current 418a. When the current parking mechanism is operated at such an intermediate state (e.g., so that 50% of the inductor current is passed on to the load), it will be appreciated that the current parking mechanism can be modulated to quickly increase or decrease the amount of current 418a provided from first phase 402a to the load.

Second phase 402b is similar to the auxiliary/additional phases of the prior examples. Specifically, controller 420b controls transistors 440 and 442 with signals 444 and 446 to control current in second phase energy storage device 450 (e.g., an inductor), which is provided to the load as second phase current 418b. As in the previous examples, the different phase currents are controlled so as to satisfy current requirements of the load, and in particular one or more of the phase currents are dynamically controlled to respond to changes in load current demand. Also similar to the prior examples, the components and control regime for second phase 402b are such that the current it provides to the load can be varied more rapidly than the first phase current.

The power conversion device of FIG. 4 can be operated in many different ways to satisfy load current demands and respond to transients. In a first example, first phase 402a is configured to handle negative transients, and the second phase 402b handles positive transient response. Transistors 426 and 428 are controlled to generate a steady state load current in the inductor 414, and the current parking mechanism passes all of the current to the load as first phase current 418a by maintaining transistor 436 enabled and transistor 434 disabled. Operating the current parking mechanism in this manner has the benefit of minimizing switching losses. However, the current parking mechanism may shunt some current to ground so that the inductor current is larger than the phase current during steady state operation. Meanwhile, second phase 402b is turned off during steady state, such that substantially all of the steady state current is provided by the first phase. In the event of a positive transient, the second phase responds to supply additional current to the load, and this augmenting is maintained until no longer required (i.e., until the first phase catches up or the needed load current drops back to the pre-transient level). In the event of a negative transient, the current parking mechanism activates to shunt some of the inductor current in the main phase so as to reduce the first phase current 418a. In either case, the system can respond quickly to satisfy the load demands, and the response time typically will be sufficient/satisfactory even when the current change was unanticipated. This arrangement also minimizes switching losses, since transistors 434, 436, 440 and 442 are either not switched or only minimally switched absent a transient.

As in the prior examples, the second/auxiliary phase may also be used to handle negative transients. In particular, the second phase can be turned on prior to a negative transient, so that it provides some portion of the steady state load current prior to the negative transient. In such a case, and in contrast to the prior example, the first phase provides less than all of the steady state current. Then, when the load current demand decreases, the high frequency operation of the second phase allows the second phase current 418b to be quickly ramped down. As the slower first phase catches up with the decrease, the second/auxiliary phase is ramped back up. On the other hand, the demanded load current might quickly return to the pre-transient level, in which case the second phase would return to steady state without the first phase necessarily decreasing its current.

In another example, first phase 402a is configured to handle positive transients. Specifically, transistors 426 and 428 are switched to generate current 416 through the inductor, some of which is diverted to ground during steady state by switching of the current parking transistors. Then, when load current demand increases, the current parking mechanism is operated to pass on more of the inductor current so as to increase first phase current 418a. It will thus be appreciated that both the first and second phase can be used for both positive and negative transients.

The exemplary systems described thus far may be configured to recognize changes in current demand in various ways. Controllers may be used to monitor various components and/or nodes of the devices. In some examples, current response is based on voltages observed at one or more nodes in the system, for example at the load. The observed voltage is then used in control loops and logic to control the various switches in the regulator phases, to thereby vary the phase currents appropriately to satisfy the change in load current demand. In other approaches, current sensing mechanisms can be used to assess the need for changing the phase currents provided to the load. Triggering signals may also be applied from external components or sources in order to indicate a change in load current demand and the need for the phases to respond appropriately.

As still another example, the control systems herein may be configured in advance, or learn dynamically and adaptively, that current needs to be varied in particular situations. For example, it may be observed that certain types of computations are always followed by an increase (or decrease) in load current demand, and further, that the increase typically is of a certain magnitude. In a processing pipeline, the fetching of particular types of instructions can be an indication that certain idle execution mechanisms will soon be brought online. Initiation of a power-up or boot sequence might be used to anticipate changes in current required for various components. Any number of examples is possible.

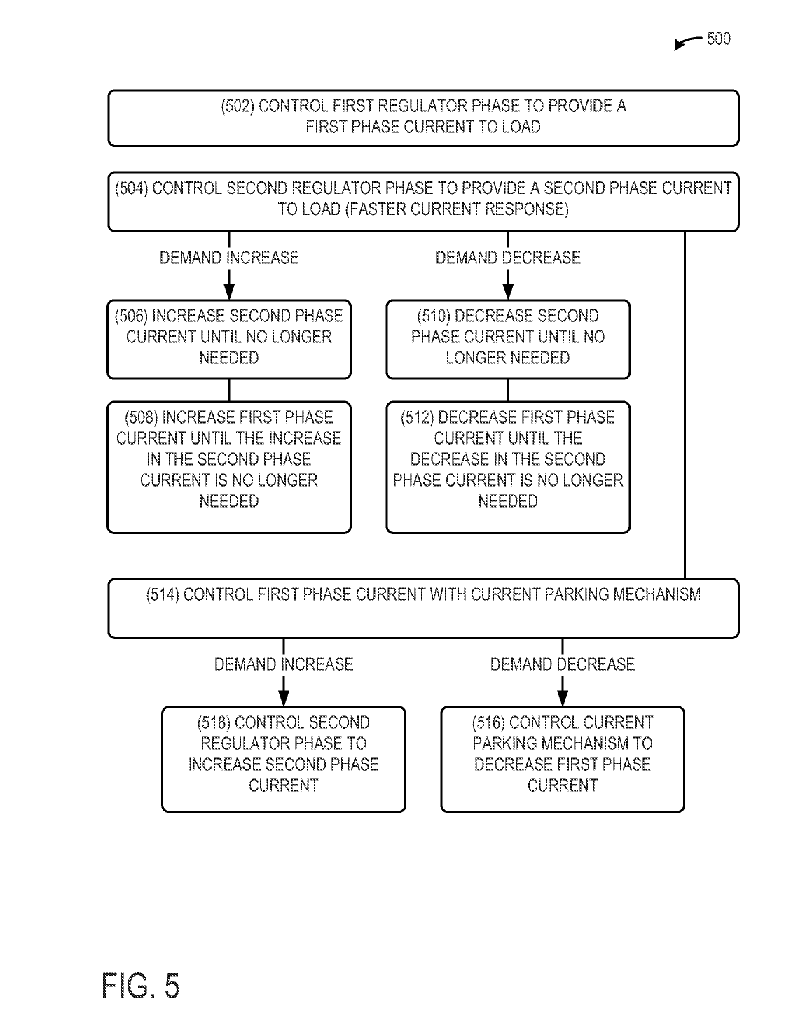

FIG. 5 depicts an exemplary method 500 of controlling electric current delivery so as to satisfy current requirements of a load. The method may be implemented in connection with the previously described embodiments, and/or in connection with systems and devices that differ in various respects from those embodiments.

At 502, the method includes controlling a first regulator phase to provide a first phase current to a load. The first phase current is based on a current generated in a storage device in the regulator phase (e.g., within an inductor as variously described with reference to FIGS. 2-4). At 504, the method includes controlling a second regulator phase to provide a second phase current to the load. Similar to the first phase, the second phase current may be based on a current generated within an inductor or other energy storage device within the second regulator phase. The two phase currents in this example are provided to the load in parallel, and are variously controlled so they together satisfy steady state and transient current requirements of the load. The phases are asymmetric—the second regulator phase is configured so that the current it provides can be varied more rapidly than the first phase current. This may be achieved by differently-configured energy storage devices, for example with inductors of different sizes, and via switching the internal components at different frequencies, as in the examples of FIGS. 2-4. These are merely non-limiting examples, however, and different response times may be realized via different topologies and methods.

The control depicted at 502 and 504 may be such that the first phase current satisfies all of the steady-state current requirements of the load, i.e., when the current requirements are substantially constant without any significant transients. In such a case, the second regulator phase is controlled so that the second phase current is substantially zero, and is not increased from that level unless there is a non-trivial increase in current demanded by the load.

Steps 506 and 508 provide an example of how the method can be carried out to respond to an increase in load current demand. At 506, the example includes controlling the second regulator phase to increase the second phase current, and maintaining that increase until it is no longer needed. Specifically, at 508, the method optionally includes controlling the first regulator phase to increase the first phase current, to thereby reduce the need for the increase provided by the second regulator phase. The second regulator phase may be gradually turned off as the first regulator phase catches up. Alternatively, if the increase is short lived, there may be no need to vary the operation of the first regulator phase. As described above, in either case the faster response capability of the second regulator phase allows the transient need to be handled quickly until the first regulator phase is again able to handle the steady state requirement of the load.

Steps 510 and 512 are analogous to steps 506 and 508, but address a decrease in load current demand, e.g., a negative transient. This example contemplates a situation in which the second regulator phase provides some of the load current during steady state, but rapidly reduces this current when the load demand decreases. Specifically, at 510 the second phase current is decreased, leveraging the more rapid response of the second regulator phase. The decrease is maintained until it is no longer needed, for example when, as at 512, the first regulator phase ramps down its current.

Further control options for fulfilling load current demands are shown at 514, 516 and 518. At 514, a current parking mechanism is used to control the first phase current. As in the example of FIG. 4, such a mechanism may be used to selectively increase or decrease how much of an internal current in the first regulator phase is passed on to the load as the first phase current. As described in FIG. 4, one use of the current parking mechanism is to rapidly turn off—either partially or completely—the first phase current. Indeed, 516 depicts responding to a negative current demand by using the current parking mechanism to decrease the first phase current. As described above with reference to FIG. 4, current parking may also be used in other implementations to increase the phase current coming out of its stage. In a current parking configuration, it will often be desirable to use the faster second regulator phase to respond to increases in demanded load current. It will be appreciated that both steps 516 and 518 provide a rapid response to whatever change arises—step 518 is relatively fast due to the characteristics of the second regulator stage (e.g., smaller inductors, higher frequency switching, planar transistors, etc.). Step 516 is relatively fast in that current parking can quickly divert/shed current to ground, which in turn quickly decreases the current passed out of the regulator phase to the load.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-phase electric power conversion device coupled between an electric power source and a load and configured to satisfy current requirements of the load, comprising:
a control mechanism;
a first regulator phase operatively coupled with the control mechanism and including a first phase energy storage device, the first regulator phase being configured to selectively provide a first phase current to the load which is based on current generated in the first phase energy storage device; and
a second regulator phase operatively coupled with the control mechanism and including a second phase energy storage device, the second regulator phase being configured to selectively provide a second phase current to the load in parallel with the first phase current, where the second phase current is based on current generated in the second phase energy storage device, and where the first phase energy storage device and second phase energy storage device are configured such that the current in the second phase energy storage device can be varied faster than the current in the first phase energy storage device.

2. The multi-phase electric power conversion device of claim 1, where during normal operating conditions in which the current requirements are substantially constant, the control mechanism controls the first regulator phase so that the first phase current satisfies substantially all of the current requirements of the load, and where the second phase current is provided only in response to an increase in load current demand.

3. The multi-phase electric power conversion device of claim 1, where the control mechanism includes a first phase switching mechanism operable to vary the first phase current and a second phase switching mechanism operable to vary the second phase current, the control mechanism being further configured to respond to a change in load current demand by dynamically varying control signals provided to one or both of the first phase switching mechanism and the second phase switching mechanism.

4. The multi-phase electric power conversion device of claim 3, where the change in load current demand is an increase in load current demand, the control mechanism being configured to respond to such increase by controlling the second phase switching mechanism to increase the second phase current until such increase is no longer needed to satisfy the current requirements of the load.

5. The multi-phase electric power conversion device of claim 4, where the control mechanism is configured to control the first phase switching mechanism to increase the first phase current so as to reduce the need for an increase in the second phase current to satisfy the increase in load current demand.

6. The multi-phase electric power conversion device of claim 3, where the change in load current demand is a decrease in load current demand, the control mechanism being configured to respond to such decrease by controlling the second phase switching mechanism to decrease the second phase current until such decrease is no longer needed to satisfy the current requirements of the load.

7. The multi-phase electric power conversion device of claim 6, where the control mechanism is configured to control the first phase switching mechanism to decrease the first phase current so as to reduce the need for a decrease in the second phase current to satisfy the decrease in load current demand.

8. The multi-phase electric power conversion device of claim 3, where the first phase switching mechanism includes a current parking switching mechanism coupled between the first phase energy storage device and the load, the current parking switching mechanism being configured to control how much of the current generated in the first phase energy storage device is provided as the first phase current to the load.

9. The multi-phase electric power conversion device of claim 8, where the control mechanism is configured to respond to an increase in load current demand by controlling the second phase switching mechanism to increase the second phase current, and to respond to a decrease in load current demand by controlling the current parking switching mechanism to decrease how much of the current generated in the first phase energy storage device is provided as the first phase current to the load.

10. The multi-phase electric power conversion device of claim 1, where the second regulator stage receives, via an auxiliary supply, a lower input voltage than received by the first regulator stage.

11. The multi-phase electric power conversion device of claim 10, where the control mechanism includes a second phase switching mechanism having one or more planar MOSFETs that are operatively coupled with the auxiliary supply and that are switched in order to control the current generated in the second phase energy storage device.

12. A method of controlling electric current delivery so as to satisfy current requirements of a load, comprising:
controlling a first regulator phase having a first phase energy storage device so as to selectively provide a first phase current to the load, the first phase current being based on current generated in the first phase energy storage device;
controlling a second regulator phase having a second phase energy storage device so as to selectively provide a second phase current to the load in parallel with the first phase current, the second phase current being based on current generated in the second phase energy storage device, where the first phase energy storage device and second phase energy storage device are configured such that the current in the second phase energy storage device can be varied faster than the current in the first phase energy storage device; and
in response to a change in load current demand, controlling one or both of the first regulator phase and the second regulator phase so as to vary one or both of the first phase current and the second phase current.

13. The method of claim 12, where during normal operating conditions in which the current requirements are substantially constant and without transients, the first regulator phase is controlled so that the first phase current satisfies substantially all of the current requirements of the load, and where the second phase current is provided only in response to an increase in load current demand.

14. The method of claim 12, further comprising, in response to an increase in load current demand, controlling the second regulator phase to increase the second phase current until such increase is no longer needed to satisfy the current requirements of the load.

15. The method of claim 14, further comprising controlling the first regulator phase to increase the first phase current so as to reduce the need for an increase in the second phase current to satisfy the increase in load current demand.

16. The method of claim 12, further comprising, in response to a decrease in load current demand, controlling the second regulator phase to decrease the second phase current until such decrease is no longer needed to satisfy the current requirements of the load.

17. The method of claim 16, further comprising controlling the first regulator phase to decrease the first phase current so as to reduce the need for a decrease in the second phase current to satisfy the decrease in load current demand.

18. The method of claim 12, further comprising controlling a current parking switching mechanism of the first regulator stage so to control how much of the current generated in the first phase energy storage device is provided to the load as the first phase current.

19. The method of claim 18, further comprising:
responding to an increase in current demand from the load by controlling the second regulator phase to increase the second phase current; and
responding to a decrease in current demand from the load by controlling the current parking switching mechanism to reduce the first phase current.

20. A multi-phase electric power conversion device coupled between an electric power source and a load and configured to satisfy current requirements of the load, comprising:
a control mechanism;
a first regulator phase operatively coupled with the control mechanism and having a first phase energy storage device, where the control mechanism is configured to generate a current in the first phase energy storage device;
a current parking switching mechanism included as part of the control mechanism, the current parking switching mechanism being controllable to control how much of the current generated in the first phase energy storage device is provided to the load as a first phase current;
a second regulator phase operatively coupled with the control mechanism and including a second phase energy storage device, the second regulator phase being configured to selectively provide a second phase current to the load in parallel with the first phase current, where the second phase current is based on current generated in the second phase energy storage device and where the first phase energy storage device and second phase energy storage device are configured such that the current in the second phase energy storage device can be varied faster than the current in the first phase energy storage device.

21. The multi-phase electric power conversion device of claim 20, where in response to an increase in load current demand, the control mechanism is configured to control the second regulator phase to increase the second phase current until such increase is no longer needed to satisfy the current requirements of the load.

22. The multi-phase electric power conversion device of claim 21, where in response to a decrease in load current demand, the current parking switching mechanism is configured to reduce how much of the current generated in the first phase energy storage device is provided as the first phase current until such reduction is no longer needed to satisfy the current requirements of the load.
